(19) United States
(12) Patent Application Publication
(10) Pub. No.: US 2017/0298566 A1
(43) Pub. Date: Oct. 19, 2017

(54) IMPROVED CARBON FIBERS

(71) Applicant: E I DU PONT DE NEMOURS AND COMPANY, WILMINGTON, DE (US)

(72) Inventors: Bryan Benedict Sauer, Wilmington, DE (US); Owen C. Compton, Wilmington, DE (US); Soonjoo Son, Wilmington, DE (US)

(21) Appl. No.: 15/513,426

(22) PCT Filed: Aug. 3, 2015
(86) PCT No.: PCT/US15/43412

§ 371 Date: Mar. 22, 2017

Related U.S. Application Data
(60) Provisional application No. 62/055,122, filed on Sep. 25, 2014.

(51) Int. Cl. D06M 11/38; D06M 15/59; D06M 15/564; C08J 5/06; D06M 101/40

(52) U.S. Cl. CPC D06M 11/38; D06M 15/564; C08J 5/06; D06M 15/59; C08J 2377/00; D06M 2101/40

(57) ABSTRACT

Provided are treated carbon fibers particularly suited for making thermoplastic composites with polyamide resin, and methods to make such treated carbon fibers.

### CROSS REFERENCE TO RELATED APPLICATIONS

This application claims the benefit of U.S. Provisional Application No. 62/055122, filed Sep. 25, 2014, now pending, the entire disclosure of which is incorporated herein by reference.

### BACKGROUND OF THE INVENTION

A thermoplastic composite (“TPC”) is a structure made from a fibrous material impregnated with a polymer resin, sometimes called the matrix resin. Due to the combination of the fibrous material and resin, TPC's typically have mechanical characteristics that allow them to be used to make large structural and load-bearing parts traditionally made from metal, for example in automotive uses. The replacement of metal with a TPC often results in substantial weight reduction and design flexibility. The fibrous material in a TPC is commonly glass or carbon fiber in a form in which there is a defined and continuous structure between individual fibers, such as in a mat, a needled mat and a felt, unidirectional fiber strands, bidirectional strands, multidirectional strands, multi-axial textiles, woven, knitted or braided textiles or combinations of these. The fibrous material is impregnated with resin in various ways, such as by layering polymer layers alternately with fibrous layers and subjecting the resulting stacked structure to heat and pressure to fully impregnate the fibrous material. The result is a hybrid between fibrous material and resin, in which the fibrous material is surrounded and impregnated by a matrix of polymer resin.

Carbon fibers are used as the fibrous material in TPC's when a combination of high stiffness and reduced weight is desired. In order to make the carbon fibers compatible with the polymer resin it is necessary to apply sizing agents to the surface of the fiber. Common sizing agents are thermoplastic polyurethanes (“TPU's”) and polyamides. Before the sizing agent is applied, the carbon fibers are subjected to various surface activating treatments to introduce functional groups on the fiber surface so that the sizing agent can properly adhere to or even covalently bond to the surface. Surface activating treatments provide oxygen containing species on the carbon fiber surface and such oxidation can be accomplished in many ways. One of many typical surface activating treatments is electrochemical oxidation, carried out in a strongly alkaline aqueous solution, followed by extensive rinsing, as disclosed in U.S. Pat. no. 5,462,799. After activation of the carbon fiber surface by such a method, sizing agent is applied. Due to the activation, the sizing agent adheres better to the surface.

Although sizing agents increase compatibility between the fiber and the polymer resin in the TPC, there is a need to improve the compatibility. Improved compatibility results in improved wetting of the fiber surface with the polymer during impregnation, and improved impregnation and adhesion of the matrix resin to the fibrous material during use of the TPC.

During the process to make TPC's, a rate determining step is the impregnation of the fibrous material with the matrix resin, which is done under pressure and heat. If the impregnation is incomplete, the TPC will have voids, resulting in inferior performance characteristics, and sometimes failure of the TPC under loads. The impregnation rate is sometimes increased by raising the pressure or increasing the temperature. These measures are far from ideal in that they require higher energy input, and often can result in oxidative decomposition of the matrix resin, which leads to TPC's having inferior performance characteristics. Longer impregnation times also reduce the cycle time to make a TPC, thus adding to cost. Maintaining a TPC under impregnation conditions for prolonged periods also results in oxidative decomposition of the matrix resin, even at lower temperatures and pressures. There is therefore an ongoing need to improve impregnation, and to reduce impregnation time.

### SUMMARY OF THE INVENTION

In a first aspect, the invention provides a method for producing carbon fibers suitable for making thermoplastic composites with polyamide resins, the method comprising the steps of:
(A) providing sized carbon fibers sized with a thermoplastic polyurethane and/or a polyamide sizing agent;
(B) treating the sized carbon fibers with an aqueous solution of an alkali metal hydroxide to produce alkali metal hydroxide-treated carbon fibers; and
(C)drying the alkali metal hydroxide-treated carbon fibers.
In a second aspect, the invention provides treated carbon fibers made by the method of the invention.

In a third aspect, the invention provides carbon fiber having thermoplastic polyurethane sizing on its surface, which sizing has a number average molecular weight (M₁), as determined by size exclusion chromatography, of less than 1000 D.

In a fourth aspect, the invention provides carbon fiber having thermoplastic polyurethane sizing on its surface, which sizing has a weight average molecular weight (M_{w}), as determined by size exclusion chromatography of less than 4000 D.

In a fifth aspect, the invention provides carbon fiber having polyamide sizing on its surface, which sizing has a number average molecular weight (Mₙ), as determined by size exclusion chromatography, of less than 5000.

In a sixth aspect, the invention provides carbon fiber having polyamide sizing on its surface, which sizing has a weight average molecular weight (M_{w}), as determined by size exclusion chromatography of less than 22,000 D.

In a seventh aspect, the invention provides carbon fiber having a sizing of partially hydrolyzed thermoplastic polyurethane and/or partially hydrolyzed polyamide.

In an eighth aspect, the invention provides TPU- and/or polyamide-sized carbon fiber having hydroxide ion on its surface in the range of 0.01-35 mmol of OH⁻/g of sizing, or 0.02-57.4 mmol of OH⁻/m² CF material, based on CF material having an areal density of 540 g/m², and having 0.3 wt % sizing, or 0.01-38.9 mmol of OH⁻/m² CF material, based on CF material having an areal density of 370 g/m², and having 0.3 wt % sizing.

In an ninth aspect, the invention provides a thermoplastic composite comprising the treated carbon fibers of the invention, and a polyamide resin selected from the group consisting of semi-aromatic polyam ides, aliphatic polyam ides, mixtures of these, and copolymers derived from the monomers used to make the foregoing.

### Abbreviations

The following abbreviations have the meanings indicated:

CF: carbon fiber

PA6T/DT: a copolymer polyamide having the comonomer moieties hexamethylene diamine, terephthalic acid and 2-methylpentamethylenediamine and terephthalic acid

PA6: polyamide 6 a polyamide comprising the monomer caprolactam

PA66: polyamide 6,6, a polyamide comprising the monomers hexamethylene diamine and adipic acid

TPC: thermoplastic composite, also referred to as a laminate

TPU: thermoplastic polyurethane

DETAILED DESCRIPTION OF THE INVENTION

### BRIEF DESCRIPTION OF THE DRAWINGS

FIG. 1. shows a pressing package utilized to consolidate laminates comprising woven CF fabric and PA66-PA6 blend via hot-pressing.

FIG. 2. shows a pressing package utilized to consolidate laminates comprising UniDirectional Non-Crimp Fabric and PA66-PA6 blend via hot-pressing.

The inventors have surprisingly found that when carbon fiber sized with a thermoplastic polyurethane and/or polyamide sizing agent is treated with an aqueous solution of an alkali metal hydroxide and dried, the carbon fiber can be more readily impregnated with polyamide resin, making it particularly suitable for the production of thermoplastic composites (“TPC's”) having superior performance characteristics. The carbon fibers of the invention typically yield lower void content TPC's than TPC's made with untreated carbon fibers consolidated under the same temperature and pressure conditions. Because impregnation of the carbon fibers of the invention is better and more rapid, consolidation times and/or pressures and/or temperatures can be reduced. Reduction of consolidation time is particularly desirable since it results in a reduction of the overall cycle time to make a TPC, and reduces the time that the polymer must be kept at an elevated temperature.

The carbon fiber may be in any form. Typical forms of carbon fiber for TPC's are non-woven structures, textiles, fibrous battings and combinations of these. Particularly preferred are: continuous material in the form of a mat, a needled mat and/or a felt, unidirectional fiber strands, bidirectional strands, multidirectional strands, multi-axial textiles, woven, knitted or braided textiles or combinations of these. Particularly preferred for TPC's are unidirectional fiber strands, also referred to as tow. Woven tow is also preferred.

When woven tow is used, the number of filaments per bundle is preferably 35 k or less, as impregnation can be difficult above this. More preferably it is 25 k or less, for example, 24 k or 12 k.

If carbon fiber fabric is used, the areal density is not particularly limited, although good results are obtained between 250-600 g/m², preferably 300-550 g/m², for example 370 g/m² or 540 g/m². The weave of the fabric is not particularly limited, although good results are obtained with a 2×2 twill weave, at all areal densities mentioned above.

The average length of the carbon fiber for use in a TPC is typically longer than 5 mm, more preferably longer than 10 mm, particularly preferably longer than 90 mm or 150 mm. In continuous fiber applications the fiber length is essentially infinite, running essentially the full length and/or width of the TPC article.

The carbon fibers for use in the method of the invention are sized with a thermoplastic polyurethane, a polyamide, or a combination of these. The TPU is not particularly limited. The polyamide sizing is also not particularly limited. Preferred polyam ides are aliphatic polyam ides, semi-aromatic polyam ides, and mixtures and/or copolymers of these. Excellent results are obtained when the sizing is a copolymer of caprolactam, hexamethylene diamine, adipic acid, and decanedioic acid.

In order to make the carbon fibers of the invention, thermoplastic polyurethane and/or polyamide sized carbon fibers are subjected to a treatment with an aqueous solution of an alkali metal hydroxide. The alkali metal hydroxide should have a pK_{b} of less than 3.5. Sodium or potassium hydroxide work particularly well (pK_{b}'s of 0.2 and 0.5, respectively).

The aqueous solution may have any hydroxide ion concentration, however, the inventors have found that particularly good TPC's result when the carbon fibers are treated with an aqueous solution having a hydroxide ion concentration of from 0.05 to 1.5 M, preferably from 0.06 to 0.35, more preferably 0.1 M.

The method used to apply the aqueous hydroxide solution to the sized carbon fibers is not particularly limited. For example, the hydroxide solution may be applied by spraying, dipping, soaking or dripping. Preferred methods are to spray the aqueous solution on the surface of the fibers, or to dip the fibers in the aqueous hydroxide solution. Soaking is preferably for 15 minutes or less.

For dipping and soaking application methods, the inventors have found that a concentration of hydroxide ions of 0.1 M gives a good result. For spraying application methods, the inventors have found that a concentration of hydroxide ion of 0.5 M-1.0 M or higher gives a good result.

The volume of hydroxide solution that is used is not particularly limited, although ideally 1.5-150 mmol of hydroxide ion/1 g of sizing is an appropriate application rate to yield carbon fibers that can be consolidated into a TPC/laminate with improved performance, preferably 20-55 mmol OH⁻/g of sizing. Application rates above 150 OH⁻ mmol/g of sizing can result in outgassing of volatiles during pressing, resulting in voids which cause TPC's made with the treated fiber to be brittle. Alternatively, the applied amount is preferably in the range of 32.4-89.1 mmol of OH⁻/m² of CF (e.g. fabric), based on an areal density of 540 g/m², and a sizing content of 0.3 wt %, or in the range of 22.0-60.4 mmol of OH⁻/m² of CF (e.g. fabric), based on an areal density of 370 g/m², and a sizing content of 0.3 wt %. The amount of sizing agent per unit weight of carbon fiber can be calculated by thermogravimetric analysis, however this value is normally provided by the carbon fiber manufacturer. Typical amounts of sizing per unit weight of commercial carbon fiber are 0.1 to 1.5 wt %, for example, 0.3 wt %.

The step of drying the treated fibers may be carried out using any method that drives off water. For example, the treated fibers may be heated, preferably to at least 60-90° C., more preferably to at least 90-110° C. The heating may be carried out, for example, in air, an inert gas or under a vacuum. If the drying is carried out without heating, the TPU and/or polyamide sizing will be less hydrolyzed than if dried at higher temperatures. The invention includes TPU- and/or polyamide-sized fibers that have been treated with an aqueous alkaline solution and dried without heating. Such fibers can be subsequently heated to effect partial hydrolysis of the sizing, or partial hydrolysis may occur upon incorporation or impregnation of the base-treated fiber in a molten polyamide resin, by virtue of the heat of the molten polyamide.

The step of drying the treated carbon fibers is preferably carried out until there is less than 0.5 wt % water based on the total weight of the fibers, more preferably less than 0.1 wt %.

The fibers of the invention are prepared without neutralizing, washing or otherwise removing the hydroxide ion from the fibers, thus the treated carbon fibers of the invention have residual hydroxide ion on their surface. Preferably the residual hydroxide ion is in the range of 0.01-35 mmol of OH⁻/g of sizing, or 0.02-57.4 mmol of OH⁻/m² CF material (for example fabric), based on CF material (for example fabric) having an areal density of 540 g/m², and a sizing content of 0.3 wt %, or 0.01-38.9 mmol of OH⁻/m² CF material (for example fabric), based on CF material (for example fabric) having an areal density of 370 g/m², and a sizing content of 0.3 wt %. Typically, if the treated carbon fibers of the invention are soaked in distilled water, for example 1-2 ml water per gram of treated fibers, the pH value of the soaking water is greater than 9, preferably greater than 10.

In one embodiment, the treated carbon fibers of the invention have partially hydrolyzed TPU and/or polyamide sizing on their surface. The average molecular weight of the partially hydrolyzed TPU or polyamide sizing may be measured by size exclusion chromatography. The number average molecular weight (Mₙ) of the TPU-sizing on the carbon fiber after treatment with base is typically less than 1000 D, preferably less than 700 D, for example 670 D. The weight average molecular weight (M_{w}) of the TPU-sizing on the carbon fiber after treatment with base is typically less than 4000 D, preferably less than 3000 D, for example 2600 D.

The number average molecular weight (Mₙ) of the polyamide-sizing on the carbon fiber after treatment with base is typically less than 5000 D, preferably less than 3000 D, more preferably less than 2000 D, for example 1300 D. The weight average molecular weight (M_{w}) of the polyamide-sizing on the carbon fiber after treatment with base is typically less than 22,000 D, preferably less than 18,000 D, for example 17,600 D.

Carbon fibers treated according to the method of the invention may be used to make TPC's using known methods. A TPC is a structure in which the carbon fibers of the invention are impregnated with a polyamide to form a consolidated unit. In one method, the treated carbon fibers may be stacked alternately with polyamide films, and then subjected to pressure and heat, causing the polyamide to melt and impregnate the treated carbon fibers, consolidating to produce a TPC/laminate. Alternatively, the treated fibers of the invention, if they are in the form of unidirectional bundles of fibers (referred to as tow), can be fed through a die, and have molten polyamide coextruded under pressure so as to impregnate the carbon fiber. This kind of TPC is referred to as unidirectional tape, because it is typically manufactured as narrow bands that are rolled up like tape, with the carbon fiber running essentially infinitely in the longitudinal axis of the tape. Unidirectional tape can also be prepared by a pressing method, as described above.

The polyamide that can be used to make a TPC with the treated fiber of the invention is not particularly limited. It can be aliphatic or semi-aromatic. Particular examples are aliphatic polyamides formed from aliphatic and alicyclic monomers such as diamines, dicarboxylic acids, lactams, aminocarboxylic acids, and their reactive equivalents. A suitable aminocarboxylic acid is 11-aminododecanoic acid. Suitable lactams include caprolactam and laurolactam. Linear, branched, and cyclic monomers may be used. Carboxylic acid monomers comprised in the aliphatic polyam ides are aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Preferably, the aliphatic dicarboxylic acids are selected from adipic acid and dodecanedioic acid. Aliphatic polyam ides comprise one or more aliphatic diamines. Preferably, the one or more diamine monomers are selected from tetramethylene diamine and hexamethylene diamine. Suitable examples of aliphatic polyamides include polyamide 6; polyamide 6,6; polyamide 4,6; polyamide 6,10; polyamide 6,12; polyamide 6,14; polyamide 6,13; polyamide 6,15; polyamide 6,16; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14. Preferred examples of aliphatic polyamides useful for making TPC's with the treated carbon fiber of the invention are poly(hexamethylene adipamide) (polyamide 66, PA66, also called nylon 66), poly(hexamethylene dodecanoamide) (polyamide 612, PA612, also called nylon 612), poly(tetramethylene hexanediamide) (polyamide 46, PA46). Blends of any of the foregoing aliphatic polyamides are also suitable. For example 50-90 wt %, more preferably 75 wt % nylon 6,6 (PA66) and 10-50 wt %, more preferably 25 wt % nylon 6 (PA6). Another example is 25-75 wt % PA66/6T blended with 25-75 wt % PA6T/DT, or more preferable PA66/6T blended with PA6T/DT in a 50/50 ratio.

Also suitable for making TPC's with the treated carbon fiber of the invention are semi-aromatic polyam ides which may be derived from one or more aromatic carboxylic acid components and one or more aliphatic diamine components. The semi-aromatic polyamides may also include monomers derived from aliphatic diacids.

The one or more aromatic carboxylic acids can be, for example, terephthalic acid or mixtures of terephthalic acid and one or more other carboxylic acids, such as isophthalic acid, substituted phthalic acid such as for example 2-methylterephthalic acid and unsubstituted or substituted isomers of naphthalenedicarboxylic acid, wherein the carboxylic acid component contains at least 55 mole-% of terephthalic acid (the mole-% being based on the carboxylic acid mixture). Particularly suitable are polyamides made from terephthalic acid or one or more aromatic carboxylic acids selected from terephthalic acid, isophthalic acid and mixtures thereof. The one or more carboxylic acids can be mixed with one or more aliphatic carboxylic acids, like adipic acid; pimelic acid; suberic acid; azelaic acid; sebacic acid and dodecanedioic acid, adipic acid being preferred. Suitable semi-aromatic polyamides comprise one or more aliphatic diamines that can be chosen among diamines having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine, bis(p-aminocyclohexyl)methane; and/or mixtures thereof.

Also suitable for making TPC's with the treated carbon fiber of the invention are mixtures of any of the above aliphatic polyamides with any one of the above semi-aromatic polyam ides.

Particularly preferred are PA66/6T (copolymer having the comonomer moieties adipic acid, hexamethylene diamine and terephthalic acid), PA6T/DT, polyamide 66, polyamide 6, and mixtures of these.

One way of measuring the quality of a TPC produced using the treated carbon fiber of the invention is to determine the void content of the TPC. The lower the void content, the better the mechanical characteristics.

Void content in TPC/laminates can be calculated based upon the difference in theoretical density (ρ_{theory}) and experimentally measured density (ρₚₗₑₐₛᵤᵣₑ), following Equation 1. Theoretical density is determined following Equation 2, where ρ_{fiber} is the density of the fiber, and ρᵣₑₛᵢₙ is the density of the resin, while measured density is the quotient of the mass and volume of a TPC/laminate.

$$\begin{matrix}\% Voids = 100 ( \frac{{ρ}_{theory} - {ρ}_{measure}}{{ρ}_{theory}} ) . & Equation 1 \\ {ρ}_{theory} = {volfraction}_{fiber} {ρ}_{fiber} + {volfraction}_{resin} {ρ}_{resin} . & Equation 2\end{matrix}$$

Carbon tow is essentially bundles of carbon filaments. Carbon tow is referred to, for example as “12 k” for tow having 12,000 filaments per bundle, or “30 k” for 30,000 filaments per bundle. The void content in a TPC/laminate will be influenced by the number of filaments per bundle. Tow having more filaments per bundle is more difficult to impregnate so the void content will be greater.

Using the treated carbon fiber of the invention in woven 12 k bundles (tow) to make a TPC, the void content is typically less than 2%. When woven 30 k tow is used, the void content is typically less than 4%, more preferably less than 3%.

The reduction of void content is commonly greater than 10%, preferably greater than 30%, as compared to a TPC made under the same conditions, but using carbon fiber that has not been treated with base. For example a reduction of 25-90% or 30-75%, as compared to a TPC made under the same conditions, but using carbon fiber that has not been treated with base.

TPC's made with the treated carbon fiber of the invention have superior Flexural modulus and/or Flexural strength, as compared to TPC's made with conventional untreated fiber consolidated under the same temperature and pressure conditions, as measured by known methods, such as ASTM protocol D790-10 “Standard test methods for flexural properties of unreinforced and reinforced plastics and electrical insulating materials”. For this 3-point bending test, a span-to-depth ratio of 16:1 is used, where depth refers to the laminate thickness. Samples are dried at 90° C. for 16 hrs, and tested quickly at 20° C. in the dried state without allowing moisture absorption. Laminate strips of 6 cm long×2 cm wide, with thicknesses of about 0.15 cm are preferred. For example, an improvement of Flex modulus of greater than 5%, preferably greater than 30% is observed, or from 5-70% is common, with 45-56% being more common, as compared to a TPC made under the same conditions, but using carbon fiber that has not been treated with base. An improvement of Flex strength of greater than 5%, preferably greater than 30%, or from 5-70% is common, with 9-47% being more common, as compared to a TPC made under the same conditions, but using carbon fiber that has not been treated with base.

TPC's made using the treated carbon fiber of the invention may show an improvement in Flex modulus or an improvement in Flex strength, or both, as compared to a TPC made under the same conditions, but using carbon fiber that has not been treated with base.

### EXAMPLES

Mechanical analysis: Flexural mechanical analysis was performed following ASTM protocol D790-10 “Standard test methods for flexural properties of unreinforced and reinforced plastics and electrical insulating materials”. For this 3-point bending test, a span-to-depth ratio of 16:1 was used, where depth refers to the laminate thickness. Samples were dried at 90° C. for 16 hrs, and tested quickly at 20° C. in the dried state without allowing moisture absorption. Laminate strips were 6 cm long×2 cm wide, with thicknesses of about 0.15 cm. These were cut to appropriate dimensions for flexural mechanical analysis using a MK-377 Tile Saw from MK Diamond Products, Inc. (Torrance, Calif.).
Void content measurement: Void content in laminate samples was calculated based upon the difference in theoretical density (ρ_{theory}) and experimentally measured density (ρₘₑₐₛₛᵤᵣₑ), following Equation 1 (above). Theoretical density was determined following Equation 2 (above), where ρ_{fiber} is the density of the fiber, and ρᵣₑₛᵢₙ is the density of the resin, while measured density is the quotient of the and of a laminate. Mass of laminates was measured using a microbalance (AT201, precision ±0.01 mg) from Mettler Instruments AG (Zurich, Switzerland). Length and width of laminates was measured with a ruler and thickness was measured in 15 separate locations with a model 599-1-31 micrometer from Brown and Sharpe Manufacturing Co. (Providence, R.I.).

### Materials and Processing:

Materials: The number of individual fibers per carbon tow used for fabric formation including weaving is defined by the designation below where, for example, 12,000 filaments per bundle is indicated by 12 k. Unsized 12 k carbon fiber (CF) grade 34-700WD 12 k was received from Grafil, Inc. (Sacramento, Calif.) and woven into a fabric of 370 g/m² areal density featuring a 2×2 twill weave. This is referred to as unsized woven Grafil 12 k fabric. Thermoplastic polyurethane (TPU)-sized (0.3 wt %) 12 k CF grade 34-700WD 12 k 0.3% R was received from Grafil, Inc. (Sacramento, Calif.) and woven into a fabric of areal density of 370 g/m² featuring a 2×2 twill weave. Thermoplastic polyurethane (TPU)-sized (0.3 wt %) 30 k CF grade 37-800WD 30 k 0.3% R was received from Grafil, Inc. (Sacramento, Calif.) and woven into a fabric of areal density of 540 g/m² featuring a 2×2 twill weave. Epoxy-sized (1 wt %) 12 k CF grade T700SC 50C was received from Toray Carbon Fibers America, Inc. (Decatur, Ala.) and woven into a fabric of areal density of 370 g/m² featuring a 2×2 twill weave. TPU-sized (0.4 wt %) 50 k CF grade Panex 35 was received from Zoltek Companies, Inc. (St. Louis, Mo.) and converted into a UniDirectional Non-Crimp Fabric (UD NCF) of areal density 150 g/m². Cutting of CF was performed using N7250 series professional shears from Kia Scissors (Seattle, Wash.).

Unsized woven Grafil 12 k fabric was also dipped in a methanol solution containing 0.3 wt % of a copolymer of caprolactam, hexamethylene diamine, adipic acid, and decanedioic acid (Elvamid® 8061) and dried at room temperature for 24 hrs. This process yielded a polyamide-sized 12 k CF fabric with approximately 0.3 wt % polyamide (Elvamid®) based on total fiber weight.

Unsized woven Grafil 12 k fabric was also spray-coated with a methanol solution containing 0.3 wt % of a copolymer of caprolactam, hexamethylene diamine, adipic acid, and decanedioic acid (Elvamid® 8023R). This Elvamid had a starting weight average MW of 28,600D.

Aliphatic nylon resin films comprising 75 wt % Nylon 6,6 (PA66) and 25 wt % Nylon 6 (PA6) with a thickness of 0.01 cm were used in some laminates. The PA66 in this composition is a heat-stabilized polyamide with a weight average molecular weight of 32,000 g/mol and was supplied by E. I. du Pont de Nemours and Company (Wilmington, Del.). PA66 has a melting point of about 260° C. to about 265° C. and a glass transition temperature of about 40° C. to about 70° C., as measured by differential scanning calorimetry (DSC) at a scan rate of 10° C./min. The PA6 in this composition is Ultramid B27, received from BASF, Co. (Florham Park, N.J.). The melt viscosity of this PA66-PA6 blend was 50 Pa s at a shear rate of 1000 s⁻¹ and 290° C.

Semi-aromatic nylon resin films were used in a blend form. PA66/6T with a glass transition of 100° C. and a melting point of 305° C. was blended with PA6T/DT at a 50/50 ratio giving a blend melt viscosity at a shear rate of 1000 s⁻¹ and 335° C. of 85 Pa s. The melting point and glass transition of this blend were 300° C. and 110° C., respectively.

PA6T/DT used in the examples is a polyamide made of hexamethylene diamine, terephthalic acid (PA6T) and 1,6-hexamethylenediamine (HMD) and 2-methylpentamethylenediamine (MPMD) (HMD:MPMD=50:50 by mole %). This PA6T/DT has a melting point of about 297° C. to about 303° C. and a glass transition temperature of about 130° C. to about 145° C. The melt viscosity at a shear rate of 1000 s⁻¹ and 335° C. of this PA6T/DT based resin is 90 Pa s. The weight average molecular weight of this resin is 25,000 g/mol.

Potassium hydroxide (KOH) was received from Avantor Performance Chemicals (Center Valley, Pa.). Ammonium hydroxide (NH₄OH) and phosphoric acid (H₃PO₄) were received from BDH Chemicals Ltd. (Poole, UK). Sodium hydroxide (NaOH) and hydrochloric acid (HCl) were received from EMD Chemicals, Inc. (Gibbstown, N.J.). All water used was ultrapurified to a resistivity of 18 MΩ·cm by a Millipore Synergy® UV water ultrapurifier (Billerica, Mass.). Absorbent Sontara® SPS™ wiping sheets used for ply drying were received from E. I. du Pont de Nemours and Company (Wilmington, Del.). A VWR® Adjustable Spray Bottle (240 mL capacity) from VWR International LLC (Radnor, Pa.) was utilized for spray application of solutions.
Laminate pressing: Resin films were dried at 90° C. for at least one hour in a model 1410 vacuum oven from VWR International LLC (Radnor, Pa.). Resin films were stacked alternately with carbon fiber and hot-pressed into laminates using a hand-operated hydraulic press model C from Fred S. Carver, Inc. (Summit, N.J.) heated to 340° C. Following hot-pressing, the laminates were cooled under pressure using a hand-operated hydraulic press model 3912 from Carver, Inc. (Wabash, Ind.) at room temperature. Kevlar® Thermount® paper was used as a frame to mitigate resin squeeze-out during pressing. Removable steel platens of dimension 16.5 cm×20.3 cm and 16.5 cm×15.2 cm were used as interfaces with the laminate. Frekote® 55-NC aerosol spray received from Henkel Corp. (Rocky Hill, Conn.) was used as a mold release agent.

Laminate measurement preparation: After pressing, laminates were cut to appropriate dimension for void measurement and subsequent flexural mechanical analysis using a MK-377 Tile Saw from MK Diamond Products, Inc. (Torrance, Calif.).

### Example 1

Generating a Laminate from TPU-sized Woven Carbon Fiber Treated by Soaking in Aqueous KOH

A 0.1 M solution of aqueous KOH was prepared by dissolving 1.14 g of KOH in 200 mL of water and poured into a glass crystallization dish. Three plies of woven TPU-sized 12 k CF from Grafil of dimension 12.7 cm×12.7 cm were submerged in the aqueous KOH solution for 15 min. The plies were then removed from the treatment solution, dried between Sontara® SPS™ sheets, and placed under vacuum in an oven set to 90° C. for 12 h.

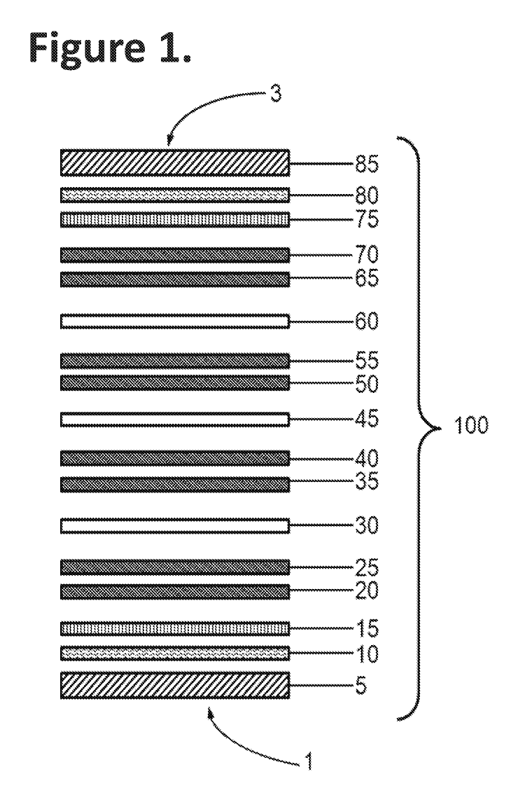

FIG. 1 illustrates the configuration of the pressing package 100 used to consolidate the treated woven CF plies and PA66-PA6 blend into a composite in the hot press. Arrow 1 indicates the face of the lower steel platen 5 (16.5 cm×20.3 cm in dimension) of the pressing package that was in contact with the face of the lower platen (not shown) of the hot press during consolidation. Arrow 3 indicates the face of the upper steel platen 85 (16.5 cm×15.2 cm in dimension) of the pressing package that was in contact with the face of the upper platen (not shown) of the hot press during consolidation. A thin layer of Frekote® silicon aerosol spray was applied to one face of each platen. The Frekote® layer 10 was applied on the top of platen 5 to ensure interface with the laminate. The Frekote® layer 80 was applied on the bottom of platen 85 to ensure interface with the laminate. A Kevlar® Thermount® non-woven paper frame 15 of outer dimension 11.4 cm×11.4 cm and inner dimension of 10.2 cm×10.2 cm was set on the Frekote® layer 10. Two plies 20 and 25 of PA66-PA6 blend (10.2 cm×10.2 cm) were stacked one on top of the other and placed inside the Kevlar® Thermount® frame 15 such that the plies were centered within the frame and minimal contact was made between resin and frame. One ply of woven TPU-sized CF 30 (12.7 cm×12.7 cm) was placed on top of PA66-PA6 blend ply 25. Two plies 35 and 40 of PA66-PA6 blend (10.2 cm×10.2 cm) were stacked one on top of the other and placed in the center of CF ply 30. One ply of woven TPU-sized CF 45 (12.7 cm×12.7 cm) was placed on top of PA66-PA6 blend ply 40. Two plies 50 and 55 of PA66-PA6 blend (10.2 cm×10.2 cm) were stacked one on top of the other and placed in the center of CF ply 45. The final ply of woven TPU-sized CF 60 (12.7 cm×12.7 cm) was placed on top of PA66-PA6 blend ply 55. The two final plies 65 and 70 of PA66-PA6 blend resin (10.2 cm×10.2 cm) were stacked one on top of the other and placed in the center of CF ply 60. Another Kevlar® Thermount® frame 75 identical in dimension as frame 15 was placed on PA66-PA6 blend resin ply 70. The pressing package was completed by placing steel platen 85 on top of the package with Frekote® layer 80 facing inward to ensure interface with the laminate.

The pressing package was inserted into a hot press pre-heated to 340° C. to consolidate the laminate. The press was closed until contact was made between the upper press platen and the pressing package and the pressure applied to the package was raised to 2.5 MPa. This position was held for 120 s then released. For the 340° C. set temperature of the press, the actual laminate temperature was about 10 degrees lower. The entire pressing package was then removed from the hot press and inserted into a press with platens at room temperature. This cold press was closed until contact was made between the upper press platen and the pressing package and the pressure applied to the package was raised to 2.5 MPa. The pressing package was removed from the cold press after cooling to room temperature and the laminate was released from removable platens 5 and 85. The laminate was then cut to dimension of 8.0 cm×8.2 cm using a rotary saw and a void content of 0.26% was measured. Two coupons of dimension 2.0 cm×8.0 cm were then cut from the laminate for flexural mechanical analysis and afforded an average flexural modulus and strength of 51.9 GPa and 745 MPa, respectively.

### Example 2

Generating a Laminate from TPU-sized Woven Carbon Fiber Treated by Dipping in Aqueous KOH

Three plies of woven TPU-sized 12 k CF from Grafil of dimension 12.7 cm×12.7 cm were treated with a 0.1 M solution of aqueous KOH, prepared as described in Example 1, by submersion for 1 s. The plies were then removed from the treatment solution, dried between Sontara® SPS™ sheets, and placed under vacuum in an oven set to 90° C. for 12 h. The plies were inserted into a pressing package with the same resin as in Example 1, and consolidated into a laminate in the same fashion as that described for Example 1, using plies of PA66-PA6 blend as the resin. The laminate was cut to dimension of 7.7 cm×7.5 cm using a rotary saw and a void content of 0.63% was measured. Two coupons of dimension 2.0 cm x 7.5 cm were then cut from the laminate for flexural mechanical analysis and afforded an average flexural modulus and strength of 52.0 GPa and 740 MPa, respectively.

### Comparative Example A

Generating a Laminate from Non-treated TPU-sized Woven Carbon Fiber

Three plies of woven TPU-sized 12 k CF from Grafil of dimension 12.7 cm×12.7 cm were inserted into a pressing package with the same resin as in Example 1, consolidated into a laminate, and cut with a rotary saw in the same fashion as that described for Example 1. The laminate was cut to dimension of 9.1 cm×9.5 cm using a rotary saw and a void content of 2.19% was measured. Two coupons of dimension 2.0 cm×8.0 cm were then cut from the laminate for flexural mechanical analysis and afforded an average flexural modulus and strength of 47.5 GPa and 535 MPa, respectively.

TABLE 1
Void content and flexural mechanical properties of laminates comprising
KOH-treated and untreated woven TPU-sized 12 k CF fabric

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 1 | TPU-sized | 0.1M KOH | 120 | 1.5412 | 1.5372 | 0.26 | 51.9 | 745 |
| | 12 k weave | (15 min | | | | | | |
| | | soak) | | | | | | |
| 2 | TPU-sized | 0.1M KOH | 120 | 1.5336 | 1.5239 | 0.63 | 52.0 | 740 |
| | 12 k weave | (dip) | | | | | | |
| A | TPU-sized | Untreated | 120 | 1.5113 | 1.4781 | 2.19 | 47.5 | 535 |
| | 12 k weave | | | | | | | |

Table 1 demonstrates the improved properties achieved by a laminate comprising TPU-sized 12 k CF that was treated with an aqueous KOH solution by either extended soaking (Example 1) or brief dipping (Example 2) in comparison to that comprising untreated TPU-sized 12 k CF (Comparative Example A). While each laminate was consolidated in the same fashion with regard to construction, resin content, pressing temperature, and pressing time, the laminates comprising KOH-treated CF exhibit a lower void content and enhanced flexural mechanical properties. This result is independent of reaction time with the hydroxide ion, verifying that only brief contact between TPU-sized CF and KOH solution is required to achieve the improved performance of a laminate comprising those treated fabrics.

### Example 3

Generating a Laminate from TPU-sized Woven Carbon Fiber Treated by Spraying with Aqueous KOH

A 0.5 M solution of aqueous KOH was prepared by dissolving 5.60 g of KOH in 200 mL of water and poured into a spray bottle. Three plies of woven TPU-sized 12 k CF from Grafil of dimension 12.7 cm×12.7 cm were treated with the 0.5 M solution of aqueous KOH by spraying 1 mL of solution with a spray bottle on the upward facing surface of each ply. Each ply of dry fabric weighed about 8 g. After spraying, the plies were placed under vacuum in an oven set to 110° C. for 10 min. The plies were inserted into a pressing package with the same resin as in Example 1, and consolidated into a laminate in the same fashion as that described for Example 1, except that the impregnation period during hot-pressing at 340° C. and 2.5 MPa was reduced from 120 s to 90 s. The laminate was cut to dimension of 9.3 cm×9.1 cm using a rotary saw and a void content of 0.63% was measured. Two coupons of dimension 2.0 cm×8.0 cm were then cut from the laminate for flexural mechanical analysis and afforded an average flexural modulus and strength of 55.3 GPa and 805 MPa, respectively.

### Comparative Example B:

Generating a Laminate from Un-treated TPU-sized Woven Carbon Fiber

Three plies of woven TPU-sized 12 k CF from Grafil of dimension 12.7 cm×12.7 cm were inserted into a pressing package with the same resin as in Example 1, and consolidated into a laminate in the same fashion as that described for Example 1, except that the impregnation period during hot-pressing at 340° C. and 2.5 MPa was reduced from 120 s to 90 s. The laminate was cut to dimension of 9.2 cm×8.7 cm and a void content of 3.55% was measured. Two coupons of dimension 2.0 cm×8.0 cm were then cut from the laminate for flexural mechanical analysis and afforded an average flexural modulus and strength of 38.2 GPa and 501 MPa, respectively.

TABLE 2
Void content and flexural mechanical properties of laminates comprising
KOH-treated and untreated woven TPU-sized 12 k CF fabric

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 3 | TPU- | 0.5M | 90 | 1.5113 | 1.4859 | 1.71 | 55.3 | 805 |
| | sized 12 k | KOH | | | | | | |
| | weave | (spray) | | | | | | |
| B | TPU- | Untreated | 90 | 1.5113 | 1.4577 | 3.55 | 38.2 | 501 |
| | sized 12 k | | | | | | | |
| | weave | | | | | | | |

Table 2 demonstrates the improved properties achieved by a laminate comprising TPU-sized 12 k CF that was treated with an aqueous KOH solution by spraying (Example 3) in comparison to that comprising untreated TPU-sized 12 k CF (Comparative Example B). While each laminate was consolidated in the same fashion with regard to construction, resin content, pressing temperature, and pressing time, the laminate comprising KOH-treated CF exhibits a lower void content and enhanced flexural mechanical properties. This result demonstrates that a small volume of aqueous KOH solution is sufficient to achieve the desired reaction and yield a laminate comprising treated TPU-sized CF with improved performance. Total application of aqueous KOH solution in Example 3 is 1 mL/8 g TPU-sized CF or 21 mmol hydroxide ion/1 g TPU-sizing.

### Example 4

Generating a Laminate from TPU-sized Woven High Filament Count Carbon Fiber Treated by Spraying with Aqueous KOH

Three plies of woven TPU-sized 30 k CF from Grafil of dimension 12.7 cm×12.7 cm were treated with the 0.5 M solution of aqueous KOH prepared in Example 3 by spraying 2mL of solution on the upward facing surface of each ply. Each ply had a dry weight of about 10g. The plies were placed under vacuum in an oven set to 110° C. for 10 min. Resin from Example 1 was used, and the plies were consolidated into a laminate as described in Example 1, except that an additional ply of PA66-PA6 blend was inserted between PA66-PA6 blend plies 20 and 25, 35 and 40, and 65 and 70. The laminate was cut to dimension of 9.1 cm×9.1 cm and a void content of 2.82% was measured. Two coupons of dimension 2.0 cm×8.0 cm were then cut from the laminate for flexural mechanical analysis and afforded an average flexural modulus and strength of 41.6 GPa and 398 MPa, respectively.

### Comparative Example C:

Generating a Laminate from Un-treated TPU-sized Woven High Filament Count Carbon Fiber

Three plies of woven TPU-sized 30 k CF from Grafil of dimension 12.7 cm×12.7 cm were inserted into a pressing package with the same resin as in Example 1, consolidated into a laminate, and cut with a rotary saw in the same fashion as that described for Example 1, except that an additional ply of PA66-PA6 blend was inserted between PA66-PA6 blend plies 20 and 25, 35 and 40, and 65 and 70. The laminate was cut to dimension of 9.2 cm×9.2 cm and a void content of 15.97% was measured. Two coupons of dimension 2.0 cm×8.0 cm were then cut from the laminate for flexural mechanical analysis and afforded an average flexural modulus and strength of 25.1 GPa and 408 MPa, respectively.

TABLE 3
Void content and flexural mechanical properties of laminates comprising
KOH-treated and untreated woven TPU-sized 30 k CF fabric

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 4 | TPU-sized | 0.5M | 120 | 1.5336 | 1.4915 | 2.82 | 41.6 | 398 |
| | 30 k | KOH | | | | | | |
| | weave | (spray) | | | | | | |
| C | TPU-sized | Untreated | 120 | 1.5336 | 1.3224 | 15.97 | 25.1 | 408 |
| | 30 k | | | | | | | |
| | weave | | | | | | | |

Table 3 demonstrates the improved properties achieved by a laminate comprising TPU-sized 30 k CF that was treated with an aqueous KOH solution (Example 4) in comparison to that comprising untreated TPU-sized 30 k CF (Comparative Example C). While each laminate was consolidated in the same fashion with regard to construction, resin content, pressing temperature, and pressing time, the laminate comprising KOH-treated CF exhibits a lower void content and enhanced flexural mechanical properties.

### Example 5

Generating a Laminate from TPU-sized Woven Carbon Fiber Treated by Dipping in Aqueous NaOH

A 0.1 M solution of aqueous NaOH for treatment of CF was prepared by dissolving 2.02 g of NaOH in 500 mL of water and 200 mL of this solution was poured into a glass crystallization dish. Three plies of woven TPU-sized 12 k CF from Grafil of dimension 12.7 cm×12.7 cm were submerged in the solution for 1 s. The plies were then removed from the treatment solution, dried between Sontara® SPS™ sheets, and placed under vacuum in an oven set to 90° C. for 12 h. Using the same resin from Example 1, the plies were consolidated into a laminate as described in Example 1. The laminate was cut to dimension of 7.6 cm×7.4 cm using a rotary saw and a void content of 1.73% was measured. Two coupons of dimension 2.0 cm×7.5 cm were then cut from the laminate for flexural mechanical analysis and afforded an average flexural modulus and strength of 54.5 GPa and 788 MPa, respectively.

### Comparative Example D

Generating a Laminate from TPU-sized Woven High Filament Count Carbon Fiber Treated by Aqueous NH₄OH

A 0.1 M solution of aqueous NH₄OH for treatment of CF was prepared by diluting 6.8 ml of 28% NH₄OH with 493.2 mL of water, which was poured into a glass crystallization dish. Three plies of woven TPU-sized 12 k CF from Grafil of dimension 12.7 cm×12.7 cm were submerged in the solution for 1 s. The plies were then removed from the treatment solution, dried between Sontara® SPS™ sheets, and placed under vacuum in an oven set to 90° C. for 12 h. Using the same resin from Example 1, the plies were consolidated into a laminate as described in Example 1. The laminate was cut to dimension of 9.3 cm×9.1 cm and a void content of 4.48% was measured. Two coupons of dimension 2.0 cm×8.0 cm were then cut from the laminate for flexural mechanical analysis and afforded an average flexural modulus and strength of 35.0 GPa and 541 MPa, respectively.

TABLE 4
Void content and flexural mechanical properties of laminates comprising
woven TPU-sized 12 k CF fabric treated with strong and weak base

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 5 | TPU- | 0.1M | 120 | 1.5396 | 1.5133 | 1.73 | 54.5 | 788 |
| | sized 12 k | NaOH | | | | | | |
| | weave | (dip) | | | | | | |
| D | TPU- | 0.1M | 120 | 1.5396 | 1.5034 | 2.35 | 42.1 | 541 |
| | sized 12 k | NH₄OH | | | | | | |
| | weave | | | | | | | |
| A | TPU- | Untreated | 120 | 1.5113 | 1.4781 | 2.19 | 47.5 | 535 |
| | sized 12 k | | | | | | | |
| | weave | | | | | | | |

Table 4 demonstrates the improved properties achieved by a laminate comprising TPU-sized 12 k CF that was treated with an aqueous NaOH solution by brief dipping (Example 5) in comparison to that comprising untreated TPU-sized 12 k CF (Comparative Example A) or that comprising TPU-sized 12 k CF treated with an aqueous NH₄OH solution. While each laminate was consolidated in the same fashion with regard to construction, resin content, pressing temperature, and pressing time, the laminate comprising NaOH-treated CF exhibits a lower void content and enhanced flexural mechanical properties than those comprising untreated or NH₄OH-treated CF. This result demonstrates the necessity of treating TPU-sized CF with a strong base, such as NaOH or KOH, to afford a resulting laminate with improved properties. Treatment with a weak base, such as NH₄OH, does not achieve this same result. NaOH and KOH have pK_{b} values of 0.2 and 0.5, respectively, while NH₄OH has a pK_{b} value of 4.8.

### Example 6

Generating a Laminate from TPU-sized Carbon Fiber in a Unidirectional Non-crimped Fabric (UD NCF) Treated by Soaking in Aqueous KOH

Using the same resin from Example 1, three plies of TPU-sized UD NCF from Zoltek of dimension 10.2 cm×10.2 cm were treated with a 0.1 M solution of aqueous KOH, prepared as described in Example 1, by submersion for 1 s. The plies were then removed from the treatment solution, dried between Sontara® SPS™ sheets, and placed under vacuum in an oven set to 90° C. for 12 h.

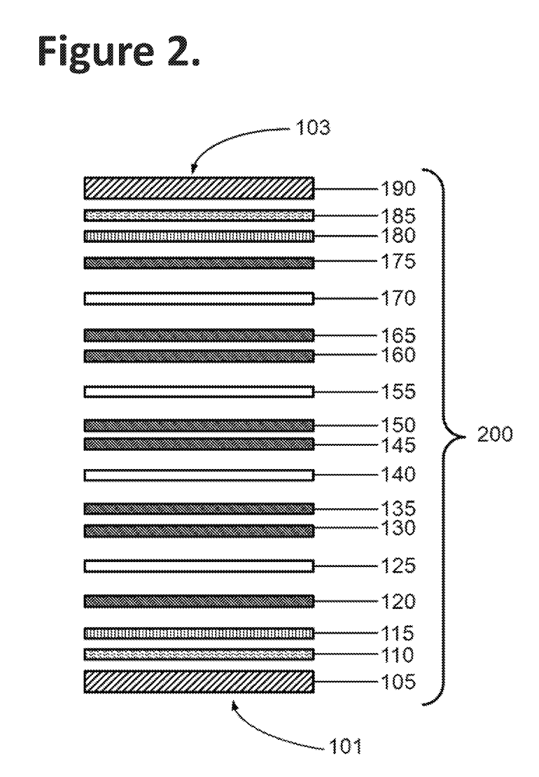

FIG. 2 shows the configuration of the pressing package 200 used to consolidate the treated UD NCF plies and PA66-PA6 blend into a composite in the hot press. Arrow 101 indicates the face of the lower steel platen 105 (16.5 cm×20.3 cm in dimension) of the pressing package that was in contact with the face of the lower platen (not shown) of the hot press during consolidation. Arrow 103 indicates the face of the upper steel platen 190 (16.5 cm×15.2 cm in dimension) of the pressing package that was in contact with the face of the upper platen (not shown) of the hot press during consolidation. A thin layer of Frekote® silicon aerosol spray was applied to the one face on each platen. The Frekote® layer 110 was applied on the top of platen 105 to ensure interface with the laminate. The Frekote® layer 185 was applied on the bottom of platen 190 to ensure interface with the laminate. A Kevlar® Thermount® non-woven paper frame 115 of outer dimension 11.4 cm×11.4 cm and inner dimension of 10.2 cm×10.2 cm was set on the Frekote® layer 110. One ply 120 of PA66-PA6 blend (7.6 cm x 7.6 cm) was placed on the Kevlar® Thermount® frame 115 such that the ply was centered on the frame. One ply of UD NCF 125 (10.2 cm×10.2 cm) was placed on top of PA66-PA6 blend ply 120. Two plies 130 and 135 of PA66-PA6 blend (7.6 cm×7.6 cm) were stacked one on top of the other and placed on UD NCF ply 125. One ply of woven UD NCF 140 (10.2 cm×10.2 cm) was placed on top of PA66-PA6 blend ply 135. Two plies 145 and 150 of PA66-PA6 blend (7.6 cm×7.6 cm) were stacked one on top of the other and placed on UD NCF ply 140. One ply of woven UD NCF 155 (10.2 cm×10.2 cm) was placed on top of PA66-PA6 blend ply 150. Two plies 160 and 165 of PA66-PA6 blend (7.6 cm x 7.6 cm) were stacked one on top of the other and placed on UN NCF ply 155. The final ply of UD NCF 170 (10.2 cm×10.2 cm) was placed on top of PA66-PA6 blend ply 165. The two final ply 175 of PA66-PA6 blend (7.6 cm×7.6 cm) was placed on top of UD NCF ply 170. Another Kevlar® Thermount® frame 180 identical in dimension as frame 115 was placed on PA66-PA6 blend ply 175. The pressing package was completed by placing steel platen 190 on top of the package with Frekote® layer 185 facing inward to ensure interface with the laminate.

The pressing package was inserted into a hot press pre-heated to 340° C. to consolidate the laminate. The press was closed until contact was made between the upper press platen and the pressing package and the pressure applied to the package was raised to 2.5 MPa. This position was held for 3 minutes then released. The entire pressing package was then removed from the hot press and inserted into a press with platens at room temperature. This cold press was closed until contact was made between the upper press platen and the pressing package and the pressure applied to the package was raised to 2.5 MPa. The pressing package was removed from the cold press after cooling to room temperature and the laminate was released from removable platens 105 and 190. The laminate was then cut to dimension of 5.6 cm×5.7 cm for void measurement using a rotary saw and a void content of 0.28% was measured. Following void measurement, two coupons of dimension 1.25 cm×5.0 cm were then cut from the laminate for flexural mechanical analysis and afforded an average flexural modulus and strength of 20.1 GPa and 449 MPa, respectively.

### Comparative Example E

Generating a Laminate from Un-treated TPU-sized Carbon Fiber in a Unidirectional Non-crimped Fabric (UD NCF)

Three plies of TPU-sized UD NCF from Zoltek of dimension 12.7 cm×12.7 cm. These CF plies were inserted into a pressing package and consolidated into a laminate as described in Example 6. The laminate was then cut to dimension of 5.7 cm×6.3 cm using a rotary saw and a void content of 3.46% was measured. Two coupons of dimension 1.25 cm×5.0 cm were then cut from the laminate for flexural mechanical analysis and afforded an average flexural modulus and strength of 17.7 GPa and 414 MPa, respectively.

TABLE 5
Void content and flexural mechanical properties of laminates comprising
KOH-treated and untreated TPU-sized UD NCF fabric

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 6 | TPU- | 0.1M | 180 | 1.5113 | 1.5071 | 0.28 | 20.1 | 449 |
| | sized | KOH | | | | | | |
| | NCF | (dip) | | | | | | |
| E | TPU- | Untreated | 180 | 1.5113 | 1.459 | 3.46 | 17.7 | 414 |
| | sized | | | | | | | |
| | NCF | | | | | | | |

Table 5 demonstrates the improved properties achieved by a laminate comprising TPU-sized UD NCF carbon fiber that was treated with an aqueous KOH solution (Example 6) in comparison to that comprising untreated TPU-sized NCF carbon fiber (Comparative Example E). While each laminate was consolidated in the same fashion with regard to construction, resin content, pressing temperature, and pressing time, the laminate comprising KOH-treated CF exhibits a lower void content and enhanced flexural mechanical properties. As the CF in these laminates is TPU-sized, but unidirectional in orientation, this result demonstrates that fabric structure does not play a role in the improved properties of laminates comprising KOH-treated carbon fiber. Indeed, laminates with improved flexural mechanical properties can be generated from fabrics regardless of fiber orientation, with the one requirement being treatment of the component sized CF plies with an aqueous ⁻OH solution.

### Example 7

Generating a Laminate with a Semi-aromatic Nylon and TPU-sized Woven Carbon Fiber Treated by Spraying with Aqueous KOH

Three plies of woven TPU-sized 12 k CF from Grafil of dimension 12.7 cm×12.7 cm were treated with the 0.5 M solution of aqueous KOH prepared in Example 3 by spraying 1 mL of solution on the upward facing surface of each ply. The plies were placed under vacuum in an oven set to 110° C. for 10 min. The plies were inserted into a pressing package with a PA6T/DT-based resin and consolidated into a laminate in the same fashion as that described for Example 1, except that the temperature was higher (390° C.) and the impregnation period during hot-pressing at this temperature and 2.5 MPa was reduced from 120 s to 90 s and the PA66-PA6 blend was replaced a semi-aromatic nylon resin (PA6T/DT). The laminate was cut to dimension of 9.1 cm×7.6 cm and a void content of 1.41% was measured. Two coupons of dimension 2.0 cm×7.6 cm were then cut from the laminate for flexural mechanical analysis and afforded an average flexural modulus and strength of 57.6 GPa and 754 MPa, respectively.

### Comparative Example G

Generating a Laminate with a Semi-aromatic Nylon Resin and Un-treated TPU-sized Woven Carbon Fiber

Three plies of woven TPU-sized 12 k CF from Grafil of dimension 12.7 cm×12.7 cm were inserted into a pressing package, and consolidated into a laminate. These plies were inserted into a pressing package with the same resin as in Example 7 and consolidated into a laminate in the same fashion as that described for Example 1, except that the temperature was higher (390° C.) and the impregnation period during hot-pressing at this temperature and 2.5 MPa was reduced from 120 s to 90 s, and the PA66-PA6 blend was replaced with a semi-aromatic nylon resin (PA6T/DT). The laminate was cut to dimension of 9.2 cm×8.7 cm and a void content of 3.55% was measured. Two coupons of dimension 2.0 cm×8.0 cm were then cut from the laminate for flexural mechanical analysis and afforded an average flexural modulus and strength of 40.0 GPa and 680 MPa, respectively.

TABLE 6
Void content and flexural mechanical properties of laminates comprising high temperature
nylon-based resin and KOH-treated and untreated woven unsized 12 k CF fabric

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 7 | TPU- | 0.5M | 90 | 1.5396 | 1.5182 | 1.41 | 57.6 | 754 |
| | sized 12 k | KOH | | | | | | |
| | weave | (spray) | | | | | | |
| G | TPU- | Untreated | 90 | 1.5113 | 1.4577 | 3.55 | 40.0 | 680 |
| | sized 12 k | | | | | | | |
| | weave | | | | | | | |

Table 6 demonstrates the improved properties achieved by a laminate comprising high temperature semi-aromatic nylon resin and TPU-sized 12 k CF that was treated with an aqueous KOH solution (Example 7) in comparison to that comprising untreated TPU-sized 12 k CF (Comparative Example G). While each laminate was consolidated in the same fashion with regard to construction, resin content, pressing temperature, and pressing time, the laminate comprising KOH-treated CF exhibits a lower void content and enhanced flexural mechanical properties.

### Example 8

Generating a Laminate from Polyimide-sized Woven Carbon Fiber Fabric Treated by Spraying with Aqueous KOH

Three plies of 0.3 wt % Elvamid®-sized woven 12 k CF of dimension 12.7 cm×12.7 cm were treated with the 0.5 M solution of aqueous KOH prepared in Example 3 by spraying 1 mL of solution on the upward facing surface of each ply. The plies were placed under vacuum in an oven set to 110° C. for 10 min. Using the same resin from Example 1, the plies were consolidated into a laminate as described in Example 1, except that the impregnation period during hot-pressing at 340° C. and 2.5 MPa was reduced from 120 s to 90 s. The laminate was cut to dimension of 9.3 cm×9.2 cm and a void content of 1.70% was measured. Two coupons of dimension 2.0 cm×8.0 cm were then cut from the laminate for flexural mechanical analysis and afforded an average flexural modulus and strength of 50.2 GPa and 758 MPa, respectively.

### Comparative Example H

Generating a Laminate from Elvamid®-sized Woven Carbon Fiber Fabric

Three plies of 0.3 wt % Elvamid®-sized woven carbon fiber fabric of dimension 12.7 cm×12.7 cm were inserted into a pressing package with the same resin as in Example 1 and consolidated into a laminate in the same fashion as that described for Example 1, except that the impregnation period during hot-pressing at 340° C. and 2.5 MPa was reduced from 120 s to 90 s. The laminate was cut to dimension of 9.2 cm×9.1 cm using a rotary saw and a void content of 4.76% was measured. Two coupons of dimension 2.0 cm×8.0 cm were then cut from the laminate for flexural mechanical analysis and afforded an average flexural modulus and strength of 32.1 GPa and 512 MPa, respectively.

TABLE 7
Void content and flexural mechanical properties of laminates
comprising woven TPU-sized 12 k CF fabric treated with KOH

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 8 | Elvamid ®- | 0.5M | 90 | 1.5113 | 1.4860 | 1.70 | 50.2 | 758 |
| | sized | KOH | | | | | | |
| | 12 k weave | (spray) | | | | | | |
| H | Elvamid ®- | Untreated | 90 | 1.5113 | 1.4426 | 4.76 | 32.1 | 512 |
| | sized | | | | | | | |
| | 12 k weave | | | | | | | |

Table 7 demonstrates the improved properties achieved by a laminate comprising Elvamid®-sized 12 k CF that was treated with an aqueous KOH solution (Example 8) in comparison to that comprising untreated Elvamid®-sized 12 k CF (Comparative Example H). While each laminate was consolidated in the same fashion with regard to construction, resin content, pressing temperature, and pressing time, the laminate comprising KOH-treated CF exhibits a lower void content and enhanced flexural mechanical properties. This result is similar to that of the laminates comprising TPU-sized 12 k CF (Example 2 and Comparative Example A) and demonstrates that the reaction with KOH with sizing is non-specific, where not only can the carbamate functional groups of TPU sizing be hydrolyzed, but that this reaction can also be achieved with the polyamide functional groups in Elvam id®.

### Comparative Example K

Generating a Laminate from Epoxy-sized Woven Carbon Fiber Treated by Spraying with Aqueous KOH

Three plies of woven epoxy-sized 12 k CF from Toray of dimension 12.7 cm×12.7 cm were treated with the 0.5 M solution of aqueous KOH prepared in Example 3 by spraying 1 mL of solution on the upward facing surface of each ply. The plies were placed under vacuum in an oven set to 110° C. for 10 min. Using the same resin from Example 1, the plies were consolidated into a laminate as described in Example 1, except that the impregnation period during hot-pressing at 340° C. and 2.5 MPa was reduced from 120 s to 90 s. The laminate was cut to dimension of 9.2 cm×8.9 cm using a rotary saw and a void content of 4.95% was measured. Two coupons of dimension 2.0 cm×8.0 cm were then cut from the laminate for flexural mechanical analysis and afforded an average flexural modulus and strength of 34.2 GPa and 526 MPa, respectively.

### Comparative Example L

Generating a Laminate from Un-treated Epoxy-sized Woven Carbon Fiber

Three plies of woven epoxy-sized 12 k CF from Toray of dimension 12.7 cm×12.7 cm were inserted into a pressing package, consolidated into a laminate, and cut with a rotary saw in the same fashion as that described for Example 1, except that the impregnation period during hot-pressing at 340° C. and 2.5 MPa was reduced from 120 s to 90 s. The same resin from Example 1 was used. The laminate was cut to dimension of 9.4 cm×9.1 cm and a void content of 4.47% was measured. Two coupons of dimension 2.0 cm×8.0 cm were then cut from the laminate for flexural mechanical analysis and afforded an average flexural modulus and strength of 32.8 GPa and 560 MPa, respectively.

TABLE 8
Void content and flexural mechanical properties of laminates comprising
KOH-treated and untreated woven epoxy sized 12 k CF fabric

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 3 | TPU- | 0.5M | 90 | 1.5113 | 1.4859 | 1.71 | 55.3 | 805 |
| | sized 12 k | KOH | | | | | | |
| | weave | (spray) | | | | | | |
| 8 | Elvamid ®- | 0.5M | 90 | 1.5113 | 1.4860 | 1.70 | 50.2 | 758 |
| | sized | KOH | | | | | | |
| | 12k | (spray) | | | | | | |
| | weave | | | | | | | |
| K | Epoxy- | 0.5M | 90 | 1.5113 | 1.4401 | 4.95 | 34.2 | 526 |
| | sized | KOH | | | | | | |
| | 12 k | (spray) | | | | | | |
| | weave | | | | | | | |
| L | Epoxy- | Untreated | 90 | 1.5113 | 1.4437 | 4.47 | 32.8 | 560 |
| | sized 12 k | | | | | | | |
| | weave | | | | | | | |

Table 8 demonstrates that no improvement in properties of a laminate comprising epoxy-sized CF is achieved by treatment of the CF with an aqueous KOH solution (Comparative Example K) in comparison to those of a laminate comprising untreated epoxy-sized CF (Comparative Example L). In contrast, Example 3 shows the results for a TPU-sized carbon fiber treated with base, and Example 8 shows the results for polyam ide-sized (Elvamid®) carbon fiber treated with base, both of which show a significant reduction in void content and drastic improvement of Flex modulus and Flex strength. All of these laminates were consolidated in the same fashion with regard to construction, resin content, pressing temperature, and pressing time. The epoxy-sized carbon fiber yields an inferior laminate, whether or not the fiber is treated with base, whereas the TPU- and polyam ide-sized carbon fibers treated with base yield improved laminates. This result shows that the type of sizing on a CF is crucial in the effectiveness of this treatment.

### Comparative Example M

Generating a Laminate from TPU-sized Woven Carbon Fiber Treated by Spraying with Aqueous KCl

A 0.5 M aqueous solution of KCl was generated by dissolving 7.48 g of KCl in 200 mL of water. Three plies of woven TPU-sized 12 k CF from Grafil of dimension 12.7 cm×12.7 cm were treated with a 0.5 M solution of aqueous KCl by spraying 1 mL of solution on the upward facing surface of each ply. The plies were placed under vacuum in an oven set to 110° C. for 10 min. Using the same resin from Example 1, the plies were consolidated into a laminate as described in Example 1, except that the impregnation period during hot-pressing at 340° C. and 2.5 MPa was reduced from 120 s to 90 s. The laminate was cut to dimension of 9.3 cm×9.2 cm and a void content of 5.26% was measured. Two coupons of dimension 2.0 cm×8.0 cm were then cut from the laminate for flexural mechanical analysis and afforded an average flexural modulus and strength of 38.5 GPa and 537 MPa, respectively.

### Comparative Example N

Generating a Laminate from TPU-sized Woven Carbon Fiber Treated by Dipping in HCl

A 0.1 M solution of hydrochloric acid was generated by diluting 1.7 mL of concentrated phosphoric acid with 198.3 mL of water. Three plies of woven TPU-sized 12 k CF from Grafil of dimension 12.7 cm×12.7 cm were treated with this 0.1 M solution of hydrochloric acid by submersion for 1 s. The plies were then dried between Sontara® SPS™ sheets and placed under vacuum in an oven set to 90° C. for 12 h. Using the same resin from Example 1, the plies were consolidated into a laminate as described in Example 1. The laminate was cut to dimension of 8.1 cm×7.9 cm and a void content of 2.85% was measured. Two coupons of dimension 2.0 cm×8.0 cm were then cut from the laminate for flexural mechanical analysis and afforded an average flexural modulus and strength of 40.6 GPa and 592 MPa, respectively.

TABLE 9
Void content and flexural mechanical properties of laminates comprising woven TPU-
sized 12 k CF fabric treated with strong acid and aqueous metal halide salt solution

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| M | TPU- | 0.5M | 90 | 1.5113 | 1.4357 | 5.26 | 38.5 | 537 |
| | sized | KCl | | | | | | |
| | 12 k | (spray) | | | | | | |
| | weave | | | | | | | |
| B | TPU- | Untreated | 90 | 1.5113 | 1.4577 | 3.55 | 38.2 | 501 |
| | sized | | | | | | | |
| | 12 k | | | | | | | |
| | weave | | | | | | | |
| N | TPU- | 0.1M | 120 | 1.5113 | 1.4693 | 2.85 | 40.6 | 592 |
| | sized | HCl | | | | | | |
| | 12 k | (dip) | | | | | | |
| | weave | | | | | | | |
| A | TPU- | Untreated | 120 | 1.5113 | 1.4781 | 2.19 | 47.5 | 535 |
| | sized | | | | | | | |
| | 12 k | | | | | | | |
| | weave | | | | | | | |
| 3 | TPU- | 0.5M | 90 | 1.5113 | 1.4859 | 1.71 | 55.3 | 805 |
| | sized | KOH | | | | | | |
| | 12 k | (spray) | | | | | | |
| | weave | | | | | | | |

Table 9 demonstrates that treatment of TPU-sized CF with non-basic solutions does not afford treated fabrics that can be incorporated into a laminate with improved properties in comparison to those of a laminate comprising untreated CF fabric. An aqueous KCl solution was chosen to demonstrate that potassium ions, also present in KOH, do not play a role in generating the desired treated CF product (Comparative Example M). HCl was chosen to demonstrate that reaction of TPU-sizing with acid does not afford the desired treated CF product (Comparative Example N). Example 3 is included to compare the results generated with TPU-sized carbon fiber treated with base (KOH), where clearly the void content is significantly reduced and the mechanical properties are improved.

### Comparative Example 0

Generating a Laminate from TPU-sized Woven Carbon Fiber Treated by Spraying with Aqueous KOH Followed by Acid Treatment

Three plies of woven TPU-sized 12 k CF from Grafil of dimension 12.7 cm×12.7 cm were treated with the 0.5 M solution of aqueous KOH prepared in Example 3 by spraying 1 mL of solution on the upward facing surface of each ply. The plies were then placed under vacuum in an oven set to 110° C. for 10 min. Each ply was then sprayed with 1 ml of a 0.005 M solution of phosphoric acid, prepared by diluting 0.1 mL of concentrated phosphoric acid with 199.9 mL of water, on the same face sprayed previously with the aqueous KOH solution. The plies were then placed under vacuum in an oven set to 110° C. for 10 min. Using the same resin from Example 1, the plies were consolidated into a laminate as described in Example 1, except that the impregnation period during hot-pressing at 340° C. and 2.5 MPa was reduced from 120 s to 90 s. The laminate was cut to dimension of 8.9 cm×8.7 cm and a void content of 3.03% was measured. Two coupons of dimension 2.0 cm×8.0 cm were then cut from the laminate for flexural mechanical analysis and afforded an average flexural modulus and strength of 40.1 GPa and 571 MPa, respectively.

### Comparative Example P

Generating a Laminate from TPU-sized Woven Carbon Fiber Treated by Spraying with Aqueous KOH Followed by Washing

Three plies of woven TPU-sized 12 k CF from Grafil of dimension 12.7 cm x 12.7 cm were treated with the 0.5 M solution of aqueous KOH prepared in Example 3 by spraying 1 mL of solution on the upward facing surface of each ply. The plies were then placed under vacuum in an oven set to 110° C. for 10 min. Each ply was then washed by soaking in 200 mL of distilled water and rinsing and repeating this process two additional times in fresh water solutions. The plies were then placed under vacuum in an oven set to 110° C. for 10 min. Using the same resin from Example 1, the plies were consolidated into a laminate as described in Example 1, except that the impregnation period during hot-pressing at 340° C. and 2.5 MPa was reduced from 120 s to 90 s. The laminate was cut to dimension of 8.9 cm×8.7 cm and a void content of 3.03% was measured. Two coupons of dimension 2.0 cm×8.0 cm were then cut from the laminate for flexural mechanical analysis and afforded an average flexural modulus and strength of 40.1 GPa and 571 MPa, respectively.

TABLE 10
Void content and flexural mechanical properties of laminates comprising woven TPU-sized
12 k CF fabric treated with KOH and either washed or treated with strong acid

| | | | Press | Theoretical | Measured | Void | Flex | Flex |
|---|---|---|---|---|---|---|---|---|
| Example | Fabric | | time | density | density | content | modulus | strength |
| number | Type | Treatment | (s) | (g/cm³) | (g/cm³) | (%) | (GPa) | (MPa) |
| 3 | TPU- | 0.5M | 90 | 1.5113 | 1.4859 | 1.71 | 55.3 | 805 |
| | sized | KOH | | | | | | |
| | 12 k | (spray) | | | | | | |
| | weave | | | | | | | |
| B | TPU- | Untreated | 90 | 1.5113 | 1.4577 | 3.55 | 38.2 | 501 |
| | sized | | | | | | | |
| | 12 k | | | | | | | |
| | weave | | | | | | | |
| O | TPU- | 0.5M KOH | 90 | 1.5113 | 1.4668 | 3.03 | 40.1 | 571 |
| | sized | (spray)/dry/ | | | | | | |
| | 12 k | 0.005M H₃PO₄ | | | | | | |
| | weave | (spray) | | | | | | |
| P | TPU- | 0.5M KOH | 90 | 1.5396 | 1.4338 | 7.38 | 28.9 | 488 |
| | sized | (spray)/dry/ | | | | | | |
| | 12 k | wash 3x | | | | | | |
| | weave | | | | | | | |

The results in Table 10 show that when the residual hydroxide ion on the carbon fiber surface is neutralized, as in Comparative Example 0, or washed away, as in Comparative Example P, a TPC made from the fiber has a high void content and has inferior flex modulus and flex strength, as compared to a TPC made in the same way but using carbon fiber treated with hydroxide and not neutralized or washed.

### Characterization of Treated Carbon Fiber

### Size Exclusion Chromatography (SEC):

Size exclusion chromatography (SEC), or gel permeation chromatography (GPC), is a simple means for identifying the molecular weights of a polymer, where the chromatogram of elution times for an analyte can be translated into molecular weights.

### Results for TPU-sized Carbon Fiber

The sizing from both untreated and base-treated TPU-sized carbon fiber was removed by soaking the carbon fiber in N,N-dimethylformamide (DMF).

The DMF extracts were evaporated on a rotary evaporator to remove excess DMF. The resulting residues were subjected to SEC using an Alliance™ 2695 separation module from Waters Corporation (Milford, Ma.), with detection by differential refractometry. Tetrahydrofuran was used as mobile phase. Two PLgel mixed-C columns were used and one PLgel 500A column was used from Agilent, all in series to separate different molecular weights. The temperature was 40° C., the flow rate was 1.00 ml/min, and the injection volume was 100 microlitres. The sample was 1 mg/ml in THF. The column calibration standard was polyethylene oxide (PEO).

The number average molecular weight (Mₙ) and the weight average molecular weight (M_{w}) of the sizing extracted from the base-treated TPU-sized carbon fiber are shown in Table 11, together with the Mₙ and M_{w} of the sizing extracted from TPU-sized carbon that was not treated with base.

TABLE 11
Molecular weights of TPU extracted from
untreated and base-treated carbon fiber

| Specimen | Mn (D) | Mw (D) |
|---|---|---|
| Untreated | 1316 | 9174 |
| KOH-treated | 668 | 2630 |

### Results for Polyamide-sized Carbon Fiber

Unsized woven Grafil 12 k carbon fiber fabric was spray coated with a methanol solution containing 1 wt % Elvamid® 8023R (a copolymer of caprolactam, hexamethylene diamine, adipic acid, and decanedioic acid) and dried at room temperature for 24 hrs. This process yielded a Elvamid®-sized 12 k CF fabric with approximately 3 wt % solids of Elvamid® sizing based on total fiber weight.

The 3 wt % Elvamid®-sized CF fabrics were sprayed with 0.5M KOH, and then dried at 110° C. for 10 minutes. The Elvamid® sizing was then extracted from the fabrics with methanol and submitted for SEC, under the same conditions as for the TPU-sizing. The average molecular weights are listed below in Table 12.

TABLE 12
Molecular weights of Elvamid ® 8023R and
Elvamid ® 8023R extracted from base-treated CF

| Specimen | Mn (D) | Mw (D) |
|---|---|---|
| Untreated | 10700 | 28600 |
| Elvamide ® 8023R | | |
| KOH-treated | 1300 | 17600 |
| Elvamide ® 8023 sizing | | |

### Surface Hydroxide Ion Concentration on Base-treated Carbon Fiber

A 15″×5″ piece of TPU-sized CF was stored in 30 mL of deionized (DI) water for 15 min, the pH of this solution was measured as 7.56. This procedure was then repeated on an equivalent sample that had been sprayed with 3 mL of 0.5 M aqueous KOH solution and dried at 110° C. under vacuum for 10 min, according to a preferred embodiment of the invention. The solution after soaking for 15 min in 30 mL of water had a pH value of 10.49. The increase in pH value from the untreated to treated samples corresponds to a three order of magnitude increase in residual hydroxide ion concentration for the treated sample. This means that there were approximately 1.5 mg of hydroxide on the CF surface (˜90 μmol).

Additional experiments and calculations of this type gave residual hydroxide ion concentrations in the range of 0.01-35 mmol OH⁻/g sizing, or 0.02-57.4 mmol OH⁻/m² carbon fiber, based on an areal density of the fibrous material of 540 g/m², and a sizing content of 0.3 wt %, or 0.01-38.9 mmol OH⁻/m² carbon fiber, based on an areal density of the fibrous material of 370 g/m², and a sizing content of 0.3 wt %.

1. A method for producing carbon fibers suitable for making thermoplastic composites with polyamide resins, the method comprising the steps of:
(A) providing sized carbon fibers sized with a thermoplastic polyurethane and/or a polyamide sizing agent;
(B) treating the sized carbon fibers with an aqueous solution of an alkali metal hydroxide to make alkali metal hydroxide-treated carbon fibers; and
(C) drying the alkali metal hydroxide-treated carbon fibers.

2. The method of claim 1, wherein the carbon fibers are in the form of continuous material in the form of a mat, a needled mat and a felt, unidirectional fiber strands, bidirectional strands, multidirectional strands, multi-axial textiles, woven, knitted or braided textiles or combinations of these.

3. The method of claim 1, wherein the alkali metal hydroxide is selected from potassium hydroxide and sodium hydroxide.

4. The method of claim 1, wherein step (B) is carried out by dipping the carbon fibers in the aqueous solution.

5. The method of claim 1, wherein step (B) is carried out by spraying the carbon fibers with the aqueous solution.

6. The method of claim 1, wherein step (B) is carried out by soaking the carbon fibers in the aqueous solution.

7. The method of claim 1, wherein the alkali metal hydroxide solution is applied to give a hydroxide application rate of about 1.5-150 mmol of hydroxide ion/1 g of sizing.

8. The method of claim 1, wherein step (C) is carried out by heating the carbon fibers.

9. The method of claim 1, wherein step (C) is carried out without heating.

10. The method of claim 1, wherein between step (B) and step (C) there is no step of washing away or neutralizing hydroxide ion on the carbon fiber.

11. Treated carbon fibers made by the method of claim 1.

12. The carbon fiber according to claim 11, having a sizing of partially hydrolyzed thermoplastic polyurethane and/or partially hydrolyzed polyamide.

13. The carbon fiber according to claim 11, having thermoplastic polyurethane sizing on its surface, which sizing has a number average molecular weight (Mₙ), as determined by size exclusion chromatography of less than 1000 D.

14. The carbon fiber according to claim 11, having thermoplastic polyurethane sizing on its surface, which sizing has a weight average molecular weight (M_{w}), as determined by size exclusion chromatography of less than 4000 D.

15. The carbon fiber according to claim 11, having polyamide sizing on its surface, which sizing has a number average molecular weight (Mₙ), as determined by size exclusion chromatography, of less than 5000.

16. The carbon fiber according to claim 11, having polyamide sizing on its surface, which sizing has a weight average molecular weight (M_{w}), as determined by size exclusion chromatography of less than 22,000 D.

17. The carbon fiber according to claim 11, having hydroxide ion on its surface in the range of 0.01-35 mmol OH⁻/g sizing.

18. The carbon fiber according to claim 11, having TPU and/or polyamide sizing and having hydroxide ion on its surface in the range of 0.01-35 mmol OH⁻/g sizing.

19. The carbon fiber according to claim 11, in the form of a mat, a needled mat and a felt, unidirectional fiber strands, bidirectional strands, multidirectional strands, multi-axial textiles, woven, knitted or braided textiles or combinations of these.

20. A thermoplastic composite comprising the carbon fibers of claim 1, and a polyamide resin selected from the group consisting of semi-aromatic polyam ides, aliphatic polyamides, mixtures of these, and copolymers derived from the monomers used to make the foregoing.
